(19) United States
(12) Patent Application Publication
(10) Pub. No.: US 2011/0270749 A1
(43) Pub. Date: Nov. 3, 2011

(54) ELECTRONIC INVOICE PRESENTATION AND PAYMENT SYSTEM

(76) Inventors: Robert Bennett, Boston, MA (US); Robert Lapides, Walpole, MA (US); John Morabito, Vienna, VA (US); Kelton Averyt, Rancho Valley, TX (US)

(21) Appl. No.: 13/097,888

(22) Filed: Apr. 29, 2011

Related U.S. Application Data
(60) Provisional application No. 61/282,968, filed on Apr. 30, 2010.

(51) Int. Cl. G06Q 40/00

(52) U.S. Cl. 705/40

(57) ABSTRACT

A method and system for generating and presenting invoices or bills from a biller to a payer. The bills are generally sent to the payer on a branded virtual site to look like the biller's website. Single or multiple bills will be presented to the payer through email notifications. The payer would have the option of paying the entire bill or portions of the bill utilizing various methods of payments, such as e-checks, paper checks, credit or debit cards as well as automatic withdrawal from a checking or savings account. The payer would also have the option of electing a paperless billing system instead of receiving both email as well as paper notifications of a particular bill or bills.

### CROSS-REFERENCE TO RELATED APPLICATIONS

The present invention claims the benefit of the filing date of U.S. Provisional Patent Application Ser. No. 61/282,968, entitled “Method and System for Electronic Invoicing”, filed on Apr. 30, 2010 and incorporates all of the material therein by reference.

### FIELD OF THE INVENTION

The present invention is directed to a method and system for allowing individuals or other entities to utilize an electronic system for the payment of bills. More specifically, the method and system of the present invention allows the individuals or other entities to view, review and manage the payment of all or a portion of the bills, each bill of which might have been generated from multiple sources.

### BACKGROUND OF THE INVENTION

Before the advent of computers, when an entity, such as a landlord or a municipality would present a bill to an individual or another entity, this bill was generally in paper form and would be hand delivered or mailed to the payer. In most instances, the payer would directly pay the bill by presenting the biller with cash or a check. Alternatively, if the biller was a merchant, the payer could present a credit card to the merchant. The credit card issuing company would then present a bill to the payer which would generally be paid by a check.

The utilization of computers and emails has greatly changed the method in which payments can be made between the biller and the payer. The biller could establish an automated system between the payer and the payer's banking institution which would automatically deduct the payment from the payer's account. Additionally, computer systems would allow for the payment between the payer and the biller utilizing an electronic check. However, the prior art system makes it difficult to streamline the payment process, particularly when multiple payments or invoices are due.

### SUMMARY OF THE INVENTION

The present invention is directed to a method and system for electronic bill presentment and payment (EBPP). This system presents customers or payers with their statement as well as providing a convenient manner to pay and track their bills. Additionally, since the present system and method can greatly reduce the use of paper statements, printing and postage costs are greatly reduced or eliminated.

Statements, bills or invoices are provided between a biller and a payer generally through the use of an email communication between these entities. This bill or invoice would inform the customer that the bill is ready to be paid. The customer would then be instructed in the manner of paying the bill as well as having an opportunity of reviewing the bill more closely online.

Additionally, a virtual site is established by the biller from the biller's website. This site is “branded” with a logo or other information indicating that the biller is the source of the virtual site. The biller, from this site, would direct the payer to the biller's URL by printing it on a paper bill and suggesting that the payer can view and pay their bills online, by being directed to a particular website.

Since the bill or invoice would appear to be generated by the biller, the customers would feel comfortable with its bill or invoice. According to the system of the present invention, the biller would have complete control of an online bill portal, thereby affording the biller the opportunity to tailor the appearance of the bill or invoice which is received by the payer.

Customers or payers can pay their bills utilizing e-check, credit/debit cards, or through the ACH from a checking or savings account. Payments can be made on the day that the invoices are received by the customer. Alternatively, the customers may schedule to pay the bill on a particular date such as by automatically deducting the amount of the bill from a checking or savings account.

Advantages of the present system to the biller would allow the biller to provide the system according to the present invention to the customer without any changes in their accounting process. The biller would create an invoice file and upload it to the software provided by the present invention for online billing. Furthermore, payment and updates are posted in the biller's accounting software and would be synchronized with the software utilized by the software of the present invention.

With respect to customers, the customers would receive email notifications of each bill or invoice and would have the opportunity to instantaneously pay the bill or view additional information about the generated invoice or bill. The customer would then view the invoice and either enters the payment information for an express payment or register to schedule a payment at a later date. Once the payment is made, the customer would receive an email confirmation with their payment amount and processing date.

The system and software of the present invention would allow the billers as well as the customers/payers to enter a secure website directly from their email by clicking a particular icon such as a “view invoice” or “pay now” button, or by accessing billing information through the biller's website. The software utilized by the present invention would allow the payer to view a copy of the generated bill or invoice, as well as allowing the payer to enter credit card or bank account information allowing the bill to be paid directly. The payer would also be allowed to register online, thereby allowing the payer to view their past history, such as past invoice payment history, to schedule payments, to set up an automatic pay system as well as to set up remittance sources and to make additional requests to the system.

According to the present system, the payer need not register, but would still be allowed to authorize payment through an e-check, credit or debit cards as well as through their checking or savings account. However, if the payer does register on the system, the payer would be allowed to view their bill history as well as to personalize the manner in which the bills are to be paid. For example, the present invention would allow a plurality of charges to be provided on a single invoice. The payer would have the ability to pay only certain of the charges on the invoice or to partially pay an invoice, as well as to schedule a payment on that invoice as long as it is not scheduled after a particular due date.

The present invention would allow the payer to suppress being sent paper bills or invoices, thereby saving the biller postage charges as well as reducing the amount of paper used by the system. Furthermore, the system according to the present invention would help the payer to negotiate the various screens of the present invention generated and sent to the payer by clicking on a particular icon.

The present invention has advantages for the biller. The biller can converge multiple invoices into a single invoice and thereby increase collections yield. For example, if the biller is a lessor, a single invoice might include the monthly rent bill as well as a bill for additional utilities, such as water, electric or gas which was initially billed to the biller from the utility company. The biller has the option to create an invoice to be paid in full, allow overpayment, or allow partial payment by selecting various options in a biller invoice file and/or biller portal selection. Alternatively, the biller can set up that the invoice be generated so that all outstanding invoices must be paid in full. The biller can update bills dynamically with late fees allowing the payer to pay online even after the due date.

The present invention would allow billers to quickly email old and new invoices to the payers with a single click of an icon as well as to immediately update any invoices based upon the payer's payments. The billers can view email statistics and/or create reports or various activities on the website, such as how many times a payer has received an invoice notice and who has clicked through the invoice notification. Furthermore, the present invention would allow payers to pay a portion of the invoice using a credit card or a portion of the invoice using an e-check.

Service fees to cover the extra cost of processing e-payments are implemented on behalf of the biller to the payer or are provided to allow the customers to pay the invention's provider directly if the biller so desires.

A tool kit has been created to assist the billers in their integration efforts with the software of the present invention. A desk top application entitled Stratus is provided with billing settings for service options to allow the automatic transfer of information between the biller's software and the software of the present invention that is not directly integrated therein.

The payer's can make customer service requests directly from the present invention's customer portal to the biller to inform the biller that certain services are lacking or that repairs must be made to the payer's premises. For example, if the biller is a lessor, the payer may inform the biller by email that one of their faucets is leaking. The biller would then have the option of emailing the payer with a response to their initial request.

Unique integration tools of the present invention would enable seamless connection with billing software applications and enable flexible e-billing solutions that can be applied to multiple bill types within the same infrastructure. For example, the payers can view and pay their town water bills, real estate tax bills, personal property tax bills and others all through the same user interface (customer portal) despite the fact that each of these bills is a different bill type and can be generated from a different billing software application. The present invention would therefore, allow flexibility in the manner in which the payer would pay the bills and would allow the payer to pay multiple bills with a single payment. In this context, the payer when presented with multiple bills within a single bill would allow the payer to select how much, if any, of each of these sub bills will be paid with a customer selected payment amount as well as directing the particular amounts to be paid from the payer's bank account as well as credit or debit card.

The present invention would allow prompt payment discounts to be enabled within an invoice or bill file, and prompt payment discounts are configurable for sub invoices within a multiple invoice.

The present invention would allow integration with a paper check conversion system that electronically deposits checks that have been scanned with images stored. Similar to the Online Bank Direct Program, the information transmitted electronically for each transaction is compared, using a matching algorithm to open invoices for the biller to match payee information such as name, amount of payment and account number (if provided). If exact matches are found, payments are applied to open invoices and a payment file prepared for import to the billing software application. This process would save billers considerable time and expense related to the reconciliation of paper checks.

The present invention would recognize when a Visa debit card is presented to use to pay a tax bill, or any other bill by analyzing the first four digits by the card used (BIN range). After determining that a Visa debit card has been proffered, the present invention would assign the special convenience fee rate specified by Visa for Visa debit cards used to pay tax bills.

The present invention would automatically enroll any paperless customers who have emailed notifications that are undeliverable back to receiving paper invoices. This same process is used to re-enroll customers who have email notifications that are blocked by SPAM filters. This feature would provide web service methods to billers and/or their print and mailing vendors to extract the paperless customer from the print file prior to printing, thereby insuring the savings associated with paperless billing.

The present invention is generally comprised of seven distinct components which work together to form a unique platform. These seven distinct components are a file exchange system, an email management system, an invoice presentment system, an online payment system, a paperless billing management system, a customer/payer portal system as well as a biller portal system. These components would provide a manner to brand or re-brand a biller's portal, upload invoices from as many different sources as desired, have all invoices available for selection, to view the invoices and/or pay the invoices to a customer based upon rules driven by both the invoice file uploaded from each different billing software and/or parameters set up in the billers portal configuration.

The present invention would keep track of which payers have a balance due and would not send an email notification to someone who paid a bill at a cashier's window as well as paid the bill online. The present invention would allow a biller to effectively allow payers to go paperless through simple self service routines provided by the invention and have peace of mind that if an email notification becomes undeliverable, that customer will be automatically re-enrolled as a paper receiving customer.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a block diagram showing the process of the present invention;

FIG. 2 is a diagram showing various email notification templates and invoice types;

FIG. 3 is a diagram showing an email notification (First Notice) sent to a payer;

FIG. 4 is a typical screen showing the manner in which a payer can register, view or print an invoice and make a payment via ExpressPayment of an invoice;

FIGS. 5 and 6 are typical invoices sent to a payer;

FIG. 7 is typical biller website with a service overview and a button to access the branded biller portal;

FIG. 8 is a typical example of a branded biller virtual site (initial landing page for the payer);

FIG. 9 is a typical search page on a branded biller website;

FIG. 10 is a branded biller website displaying results of payers from a search;

FIG. 11 is a branded biller website displaying all bills for a registered user for a specific email address;

FIG. 12 is a branded biller website showing how an express payment can be made;

FIG. 13 is a branded biller website showing how payments can be scheduled;

FIG. 14 is a branded biller website showing an email payment notification;

FIG. 15 is a branded biller website showing the manner in which a payer can provide for automatic payment;

FIG. 16 shows a screen illustrating flexible multi invoices within one invoice and a screen showing partial payment by invoice;

FIG. 17 is a screen showing online bank direct payment;

FIG. 18 is a screen showing an unmatched online bank direct payment;

FIGS. 19 and 20 show branded biller screens authorizing a paperless registration;

FIG. 21 is a branded customer screen showing a typical customer portal system;

FIG. 22 is a biller portal screen displaying the comprehensive data management features;

FIG. 23 is a typical invoice screen allowing the biller to search invoices;

FIG. 24 is a screen showing a settled batch history, one of the options in the virtual terminal section of the biller portal; and

FIGS. 25 and 26 are screens showing additional features found in the biller portal.

### DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

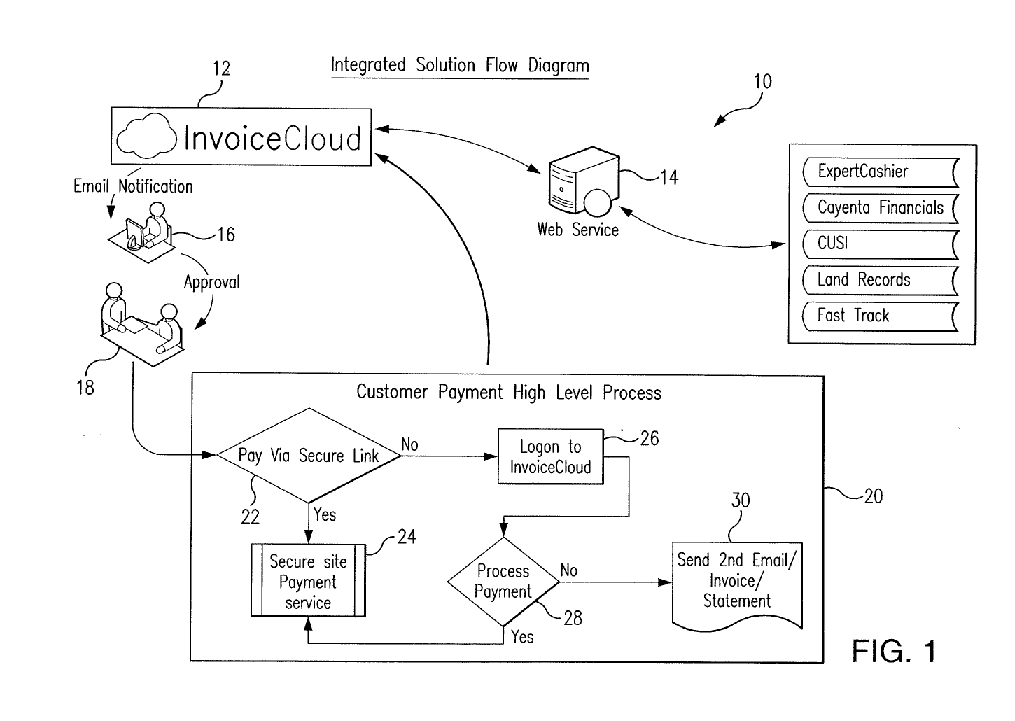

As illustrated in FIG. 1, the method and system of the present invention 10 utilizes software to manage the process of submitting bills to a payer, receiving payment from the payer as well as notifying the payer that the bills have been paid. Additionally, the present system would allow both the biller and the payer to customize the manner in which the invoices are presented, searched and paid.

The software 12 of the present invention is integrated with the software of the biller by directly downloading the software to the biller or utilizing the tool kit entitled “Stratus” to move and synchronize the data. This system helps to move and synchronize the data between the biller system and the platform created by the present invention. This system helps bridge the gap between software applications that are unable to do a complete integration with the platform of the present invention but have the ability to import and export data. Stratus would upload invoice files to the platform of the present invention according to any number of scheduled tasks. These files may be in the format of the present invention or a third party format which will be converted for import. Stratus would upload payment files to the platform of the present invention according to any number of scheduled tasks. These files may also be in the format of the present invention or a third party format which will be converted to import. Stratus would download payment files from the platform of the present invention according to any number of scheduled tasks. These files may be received in a number of formats for import into the biller's systems.

A web server 14 will be utilized to move information between the platform of the present invention, each of the billers as well as interacting with the payers as well as the methods of payment. Each of the payers 16 will be notified by email of the existence of one or more invoices. This is also accomplished by the payer logging in to the billers website at 26. The payer would initiate payment at step 28 through a secure payment service 24 by a secure link 22. If the payment was approved at 18, the payer would be informed by an appropriate email. If the payment has not been approved, the payer would be informed of this situation through the use of a separate email notification at 30.

The file exchange system with the Stratus file conversion engine would enable the system to automatically retrieve invoice information from billing software applications as well as to convert the invoicing information into a format that can be imported to the invoice presentment system and will be described. The present system would also allow for the export of any reformatted invoice file using standard web services. The present invention would also validate the correctness of the invoice data retrieved by the invoice presentment system. Furthermore, the present invention would allow for automatic scheduling of these file extractions, conversions, exports and validations.

The file exchange system would allow for the importing of payment files created by the online payment system, the automatic scheduling of the importing of payment files created by the online system, conversion of file formats created by the billing software application to and from IC formats for the conversion and uploading to the present invention from billing software application including expiration dates for invoices and a multiplicity of other parameters. It would also allow for the import and conversion to billing software application file format from the software of the present invention as well as the conversation and uploading for a billing software application to the software of the present invention for all daily payments and invoice adjustments.

The file exchange system of the present invention would contain a customer change log which is an import to the billing software for customer information updates such as, but not limited to, email addresses, phone numbers as well as paper or paperless billing status. The present invention would also allow for ACH rejected e-checks to enable automatic reversal of cash receipts to an open accounts receivable. The present invention would convert an upload from a billing software file format with new balance information from the invoice presentment system and can calculate recent payments and/or adjustments to open invoices and post the payments or adjustments in payment history for the customers and/or biller's reference. The present invention adjusts by individual amount and type of payments by cash, check as well as credit and is used to update the balance due amount to an open invoice in the invoice presentment system and post the adjustment in payment history for the customer's and/or biller's reference.

Unlike other file exchange systems that upload and download data, the file exchange system of the present invention includes an instruction set which allows the biller to set several important parameters that govern the invoice notification, payment and business rules for a particular invoice. Within an invoice file with thousands of invoices, the biller can send flags that allow certain invoices to be paid in full only, others could accept partial payments and/or overpayments. Some invoices may have multiple invoice notifications spanning a biller's selected time frame and others may have only one invoice notification as selected by the biller. Some of these invoices could select a certain bill template with a completely different look and feel that other invoices would select the use of a different bill template.

The settings of parameters that can be set by the biller in the flexible invoice file specification can include, but are not limited to, a balance forward which automatically makes the prior bill within the same bill type for the customer to become “view only” because any balance due has been added to a new invoice. These parameters would also include the inclusion of interest fees, penalties, adjustments, date driven activities, as well as allowing for partial payments, a late fee amount, the number of days after an invoice issued when late fees are invoked, prompt payment discounts if any, interest fees, penalty fees as well as multiple invoice types for a multiple of bills, such as but not limited to rent, water bills, gas bills, electric bills, boat mooring fees, parking tickets and library fees.

The file exchange system would allow a customer to select how much, if any of each sub bill or multi bill that the consumer chooses to pay at once. For example, if a single bill includes a cost of electricity, cable and telephone components, the customer can select how much of each of these component bills he or she will pay with a single payment.

The file exchange system would allow uploading of invoices from multiple billing software applications into a single biller portal and all of which is viewable by a customer in their customer portal, or by an administrative person associated with the biller in the biller portal. The file exchange system of the present invention includes a set of unique web services created as an integration tool kit allowing for easy integration with billing software applications and secure transfer of the multitude of files. The file exchange system would provide methods to replace existing invoices with updated invoices, methods to adjust balances on existing invoices, methods to calculate payments and/or adjustments based upon a comparison algorithm between a prior balance and a new balance as uploaded for each invoice. Service fees can be included in the invoice files to accommodate either credit card or ACH transactions because the online payment system of the current invention does not know in advance what option the payer will choose.

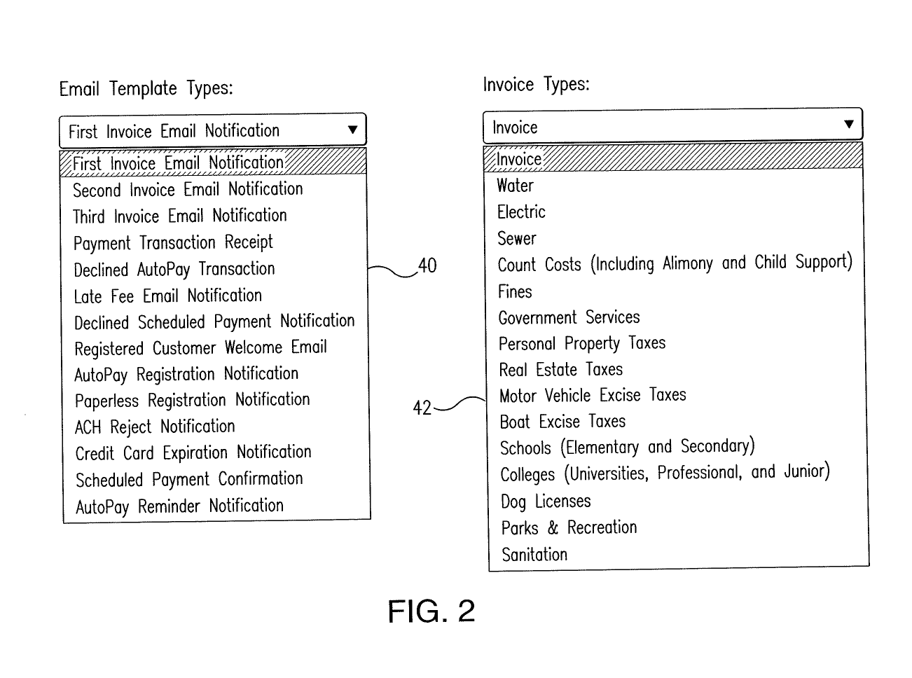

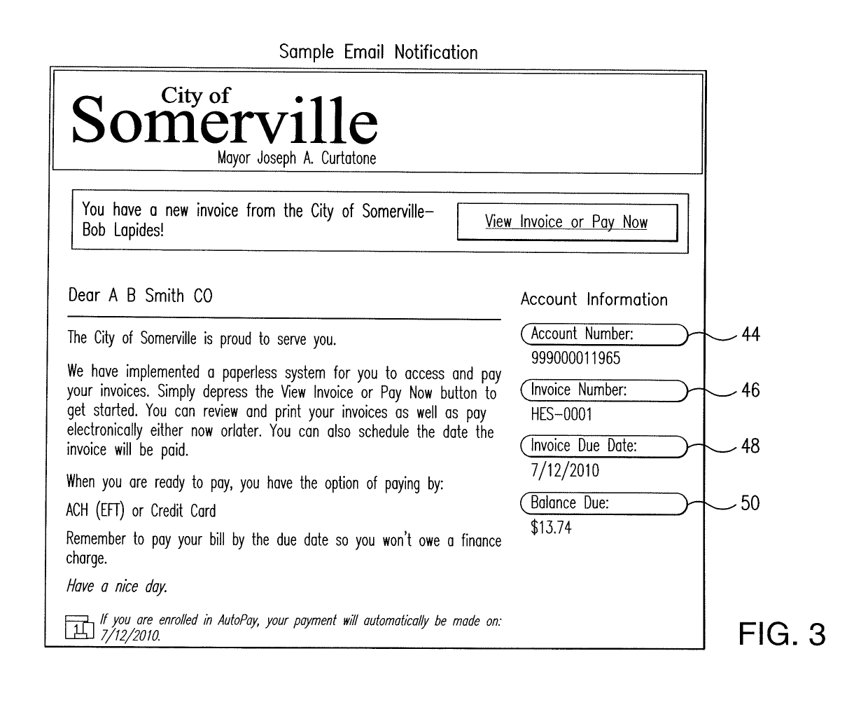

The email management system is illustrated with respect to FIGS. 2 and 3. All email notices sent to the payers are customizable by the biller and automatically triggered by events or parameters from the file transfer system or configured by the biller in the biller portal system. A screen is provided to the biller which includes a drop down menu 40 showing various email notification template types as well as a drop down invoice menu 42 listing the types of bills included in the invoice. As can be appreciated, other email templates as well as invoice type can be utilized. A screen would be provided to the biller allowing the biller to use a word processor type editor to easily and rapidly modify the email templates. Both the image management and the color scheme can be modified by the software of the present invention, by integrating the software with the biller's software or the biller himself.

Email notifications sent to the payers are triggered by a number of parameters which include but are not limited to various states, events, the customer registration, customer payments, customer enrollment in the paperless system, customer enrollment in auto pay, credit card expiration as well as a number of invoices sent to the payer without payment. As can be appreciated, if an invoice is paid, no reminders would be sent to the payer. Other parameters include a welcome letter sent to the payer, an ACH rejection notification which is sent to both the payer and the biller, scheduled payment confirmation, upcoming auto payment reminders, a late fee notification, an auto pay payment which has been declined as well as scheduled payments which have been declined. Additionally, all email addresses sent from a do not reply heading have “alias” email headers to allow the automatic redirection of responses to the customer's biller to the customer “reply” to an email notification sent by the present invention. The email management system also uses an authorizer SMTP relay of emails automatically blocked to keep emails from going to customers who complain of receiving SPAM.

FIG. 3 shows a sample email indicating to the payer that a new invoice has been forwarded. As shown in FIG. 3, an email could include the payer's account number 44, an invoice number 46, an invoice due date 48 as well as an indication 50 of the balance due on the invoice.

The payer would generally view the invoice through the use of the aforementioned email notification or login on to the biller's website. When a new invoice is loaded into the system and the customer has an email address in the system, the email will be sent to the payer. The email simply notifies the payer that a new invoice is available to view and/or pay online. The payer can also access the invoice directly from its email by clicking on the view invoice button. The email would also have a pay now button which the payer would also click to arrange for the payment of the invoice.

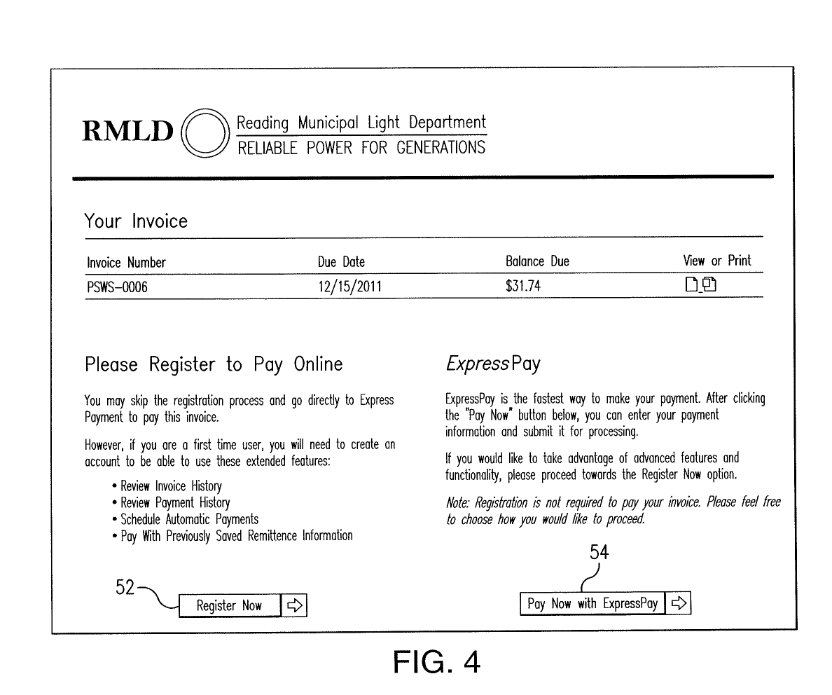

FIGS. 4, 5 and 6 are directed to the invoice presentment system. This system enables the display of current or past invoices “on demand” either by rendering the invoice based upon uploading current invoice data and instantaneously creating the invoice based upon a previously stored invoice or by linking to a previously stored copy of the invoice using the PDF of that invoice. Invoices are presented as identical or near identical references of the customer's paper bills.

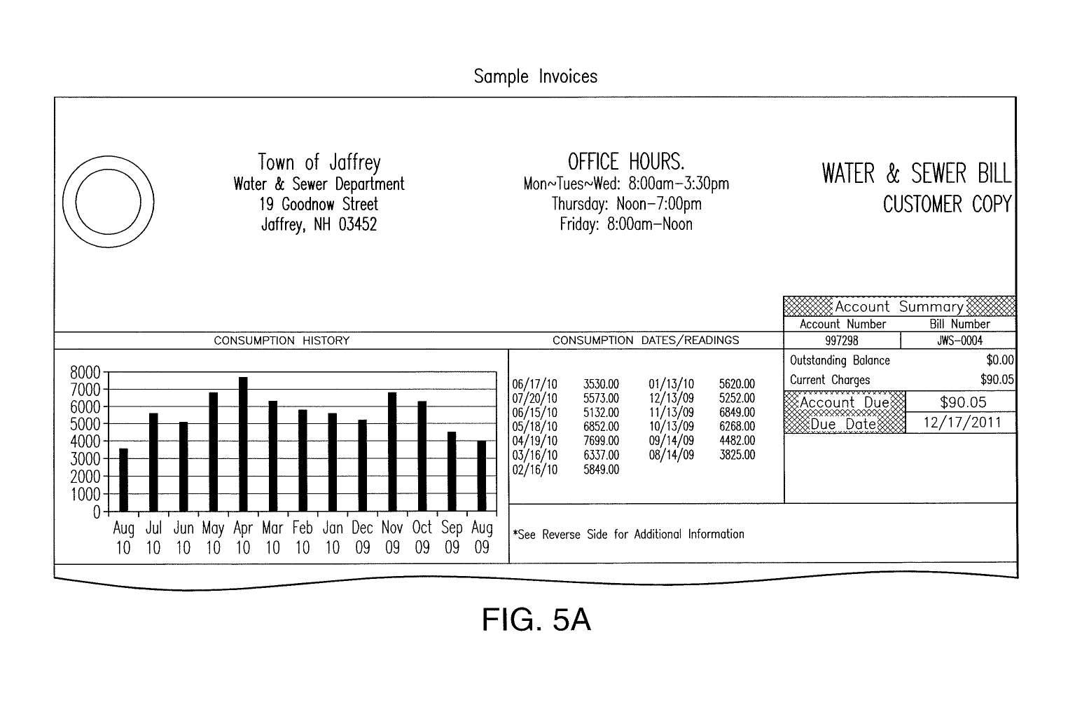

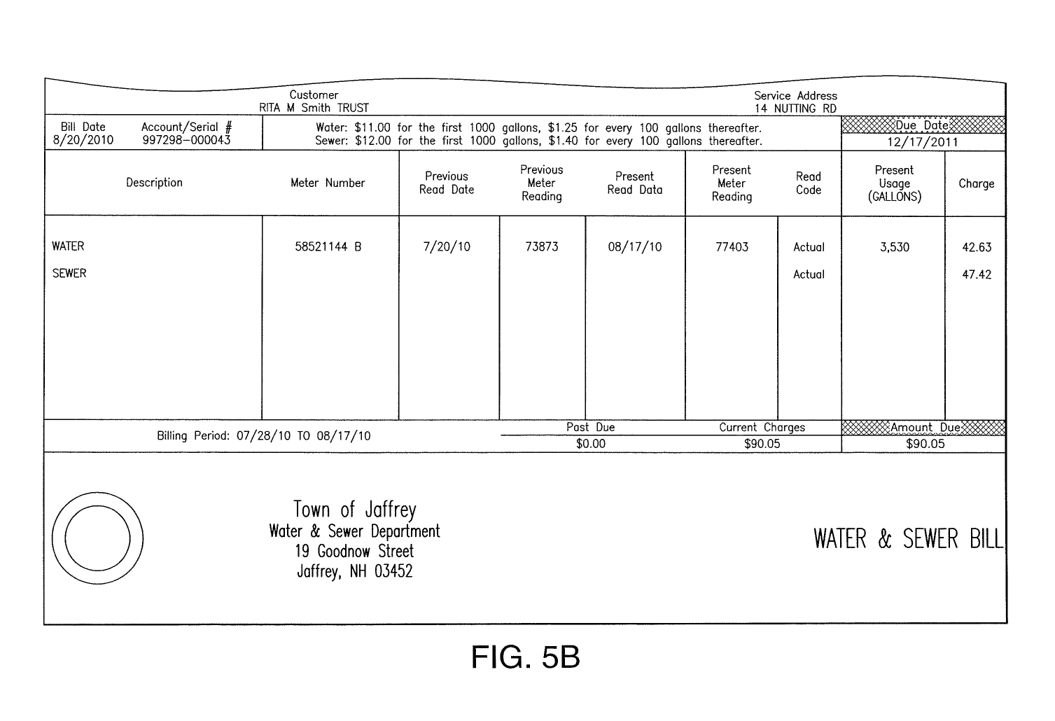

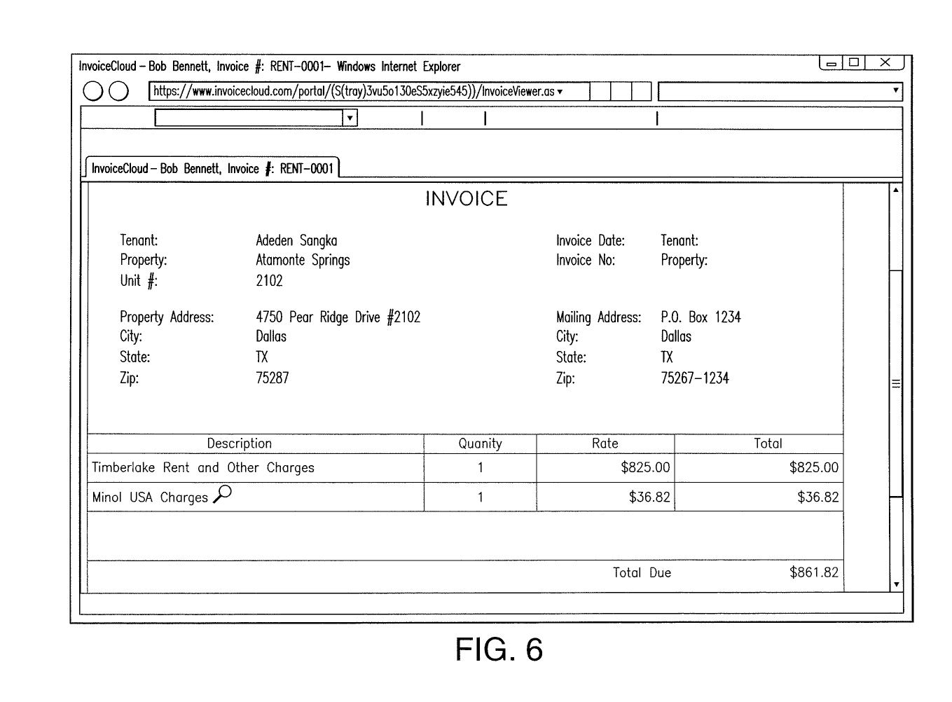

As shown in FIG. 4, the invoice appears to be generated directly from the biller, in this case The Reading Municipal Light Department. This email includes information relating to the particular invoice as well as allowing the payer to register and giving the payer an opportunity to review various information relating to the payer's invoices. By clicking on button 52, the payer would register and establish an account. Clicking on button 54 would allow the payer to enter payment information relating to that particular invoice. Typical invoices are shown in FIGS. 5 and 6 which include information relating to one or more invoices as well as additional information relating to the payer's history.

Dynamic invoice templates allow the invoices to be generated based upon underlying data specified in an invoice file or multiple as well as nested bills within a single bill allows for flexible payment options. The payer can pay the entire multi bill invoice as well as full payment or some of the items billed as well as partial payments for other items billed.

The present invention would allow invoices and sub invoices to be updated based upon newly generated bills or payments that were made. For example, an invoice for rent which is due on the first day of the month can be updated with a sub invoice for water use on the third day of the month and/or other sub invoices for covering other charges such as shown in FIG. 6. If the current invoice has already been paid, these new sub invoices will automatically be added to the next month's rent bill.

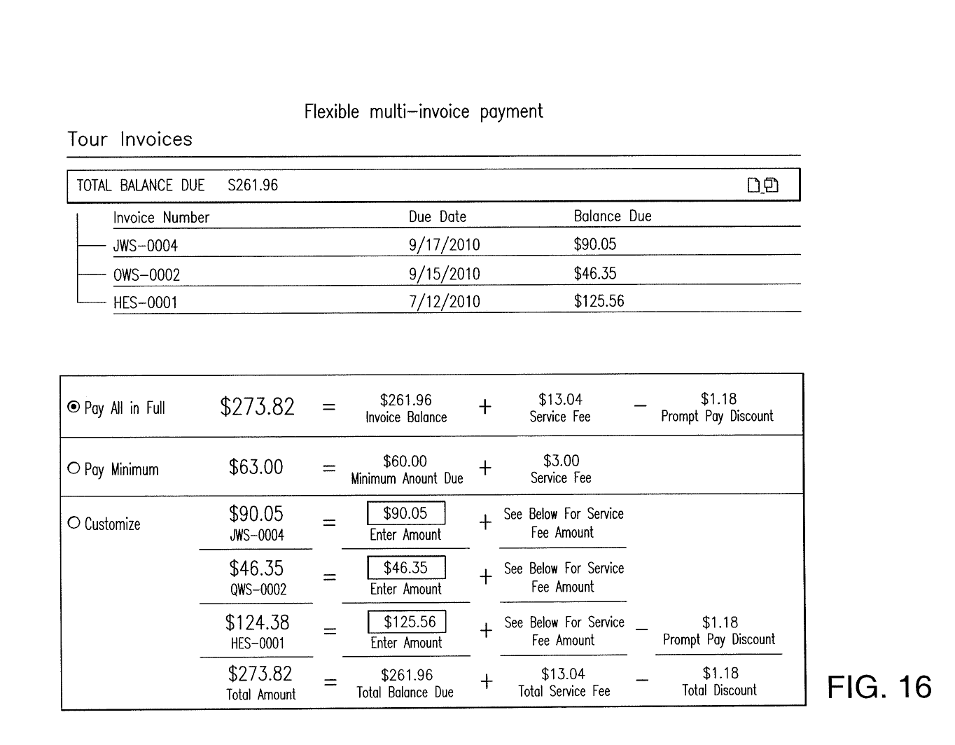

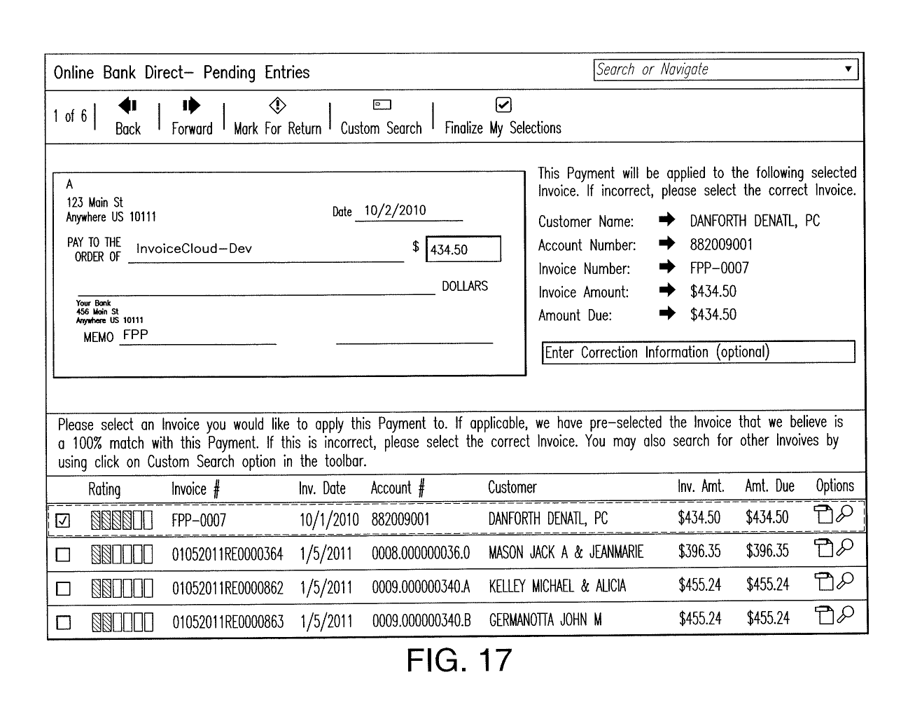

The invoice presentment system employs a flexible production model which enables the customer to select an HTML or PDF rendering of invoices using templates stored on a global unique identifier (GUID) and linked by the invoice descriptor in the invoice file for a direct link to be stored on remote PDFs. Customers view the invoices by linking from a biller's website to a branded virtual site such as shown in FIG. 4. The biller's have the ability to allow customers to pay bills after a due date regardless of how penalties and/or interest is calculated by the billing software application for missing the due date. The present invention includes methods that notify the billing software application of which customer is requesting a view of the bill which would allow the web service to instantaneously transfer the most up to date balance due including any interest and late fees calculated by the billing software application in real time. As can be appreciated, the present invention would only request updates to the invoice if the invoice is beyond the due date and the invoice file indicates that it requires updating in real time after this date. Prompt payment discounts can be enabled within the invoice file and prompt payment discounts are configurable for sub invoices within a multiple invoice as is shown in FIGS. 16 and 17 which will be discussed in more detail herein below.

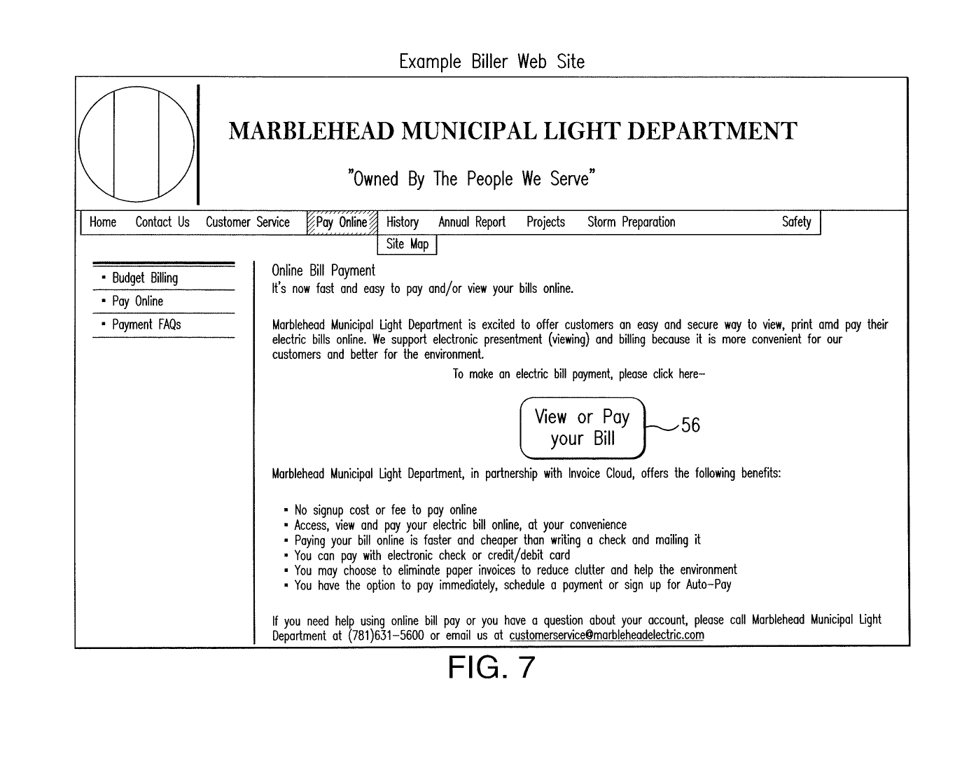

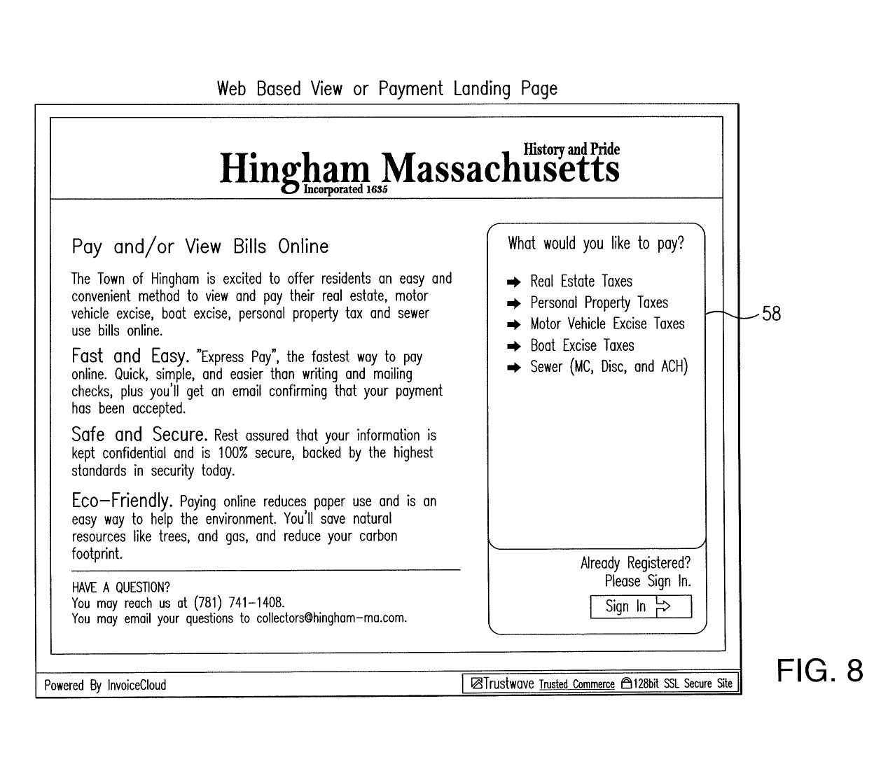

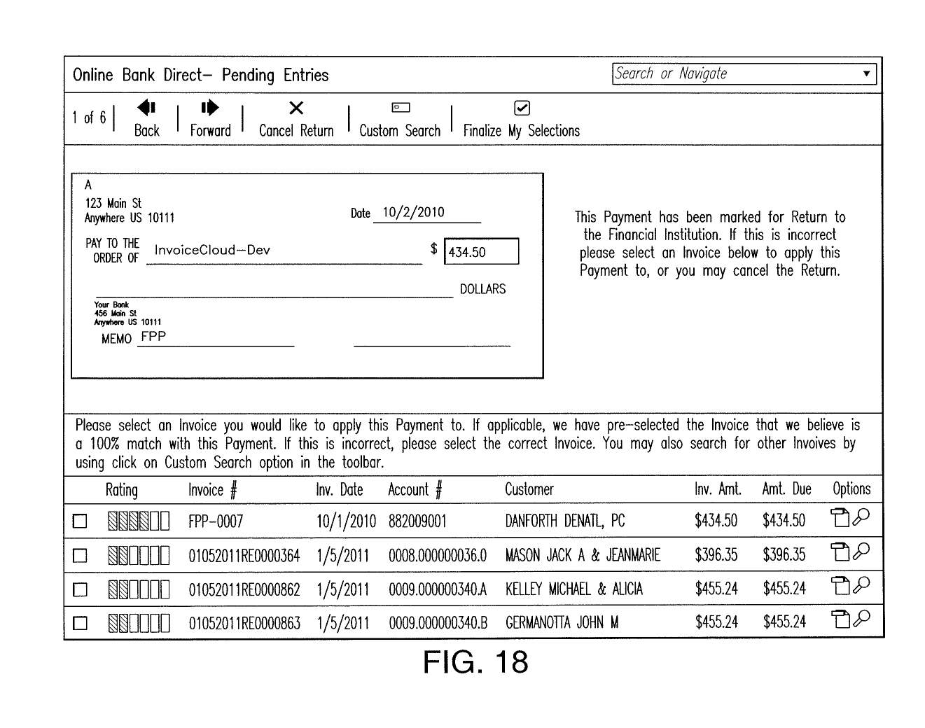

FIGS. 7-18 illustrate various features of the online payment system. The system according to the present invention would allow the payers to pay bills online allowing payment methods configured through the settings and/or the parameters described in the invoices with respect to the biller portal system. For example, FIG. 7 illustrates a biller website with a service overview and button to launch in a branded biller portal. FIG. 7 includes a button 56 which would allow the payer to enter the branded secure virtual site to view or pay a particular bill. FIG. 8 is an example of a branded virtual site-initial landing page for payer. Box 58 in FIG. 8 would allow the payer to select which bill type the payer would like to pay by clicking on one of the choices listed.

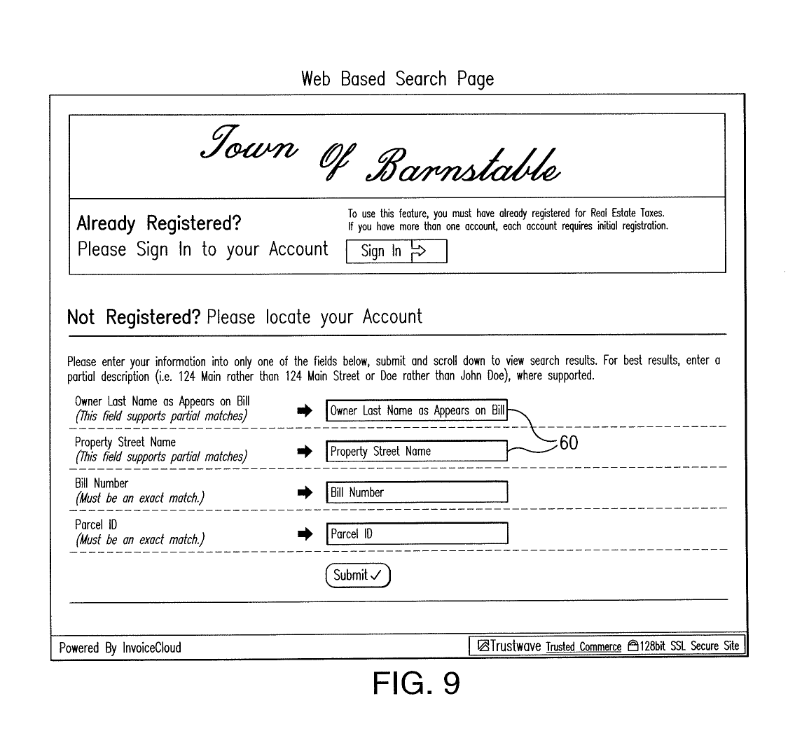

FIG. 9 is directed to a branded search page which would appear after the payer chooses to register as shown in FIG. 4. Various information relating to the payer would be entered into at least one of the boxes 60. The search criteria can vary by invoice type and biller. For example, real estate information, in many states is public information so that a partial match on the last name is all that is necessary to present names that match. Other types of bills, such as motor vehicle or utilities as an example, would require an exact match on typically two of the fields.

The current invention would allow for several methods of online payment selectable by the payer, but within parameters allowed by the biller. The methods of payment and parameters allowable as options to the billers include, but are not limited to partial payment, full payment, overpayment, payment with a credit card, payment with an electronic check, multi-tender payments which includes a partial payment with an e-check or multiple e-checks from the same bank account as selected by the payer with a balance or less than a full balance paid by a credit card or multiple credit cards.

FIGS. 16 and 17 illustrate an invoice having multiple sub bills thereon. As previously indicated, based upon the parameters set up by the biller, the payer can pay all of the bills, a single bill or partial payment of one or more of the bills. Additional parameters include scheduled payments, scheduled partial payments, auto payments, scheduled overpayments, multi-invoice payments, partial payments of sub invoices within a multi-invoice, payments with prompt payment discounts, payments of invoices with late fees, interest and penalties.

The present invention includes the ability of electronically uploading home banking transactions from online banks for billers enrolled in the company's online bank direct program. Transactions uploaded from online bank transactions are pulled for enrolled billers from the MasterCard RPPS service and the information transmitted electronically for each transaction is prepared, using a matching algorithm to open invoices for that biller to match the name, amount of payment as well as account number if provided. If exact matches are found, payments are applied to open invoices and a payment file is prepared for import to the billing software application. This process saves billers considerable time and expense related to the reconciliation of paper checks that are sent by online banks to billers that area not enrolled in the online banking network.

The current invention allows integration with a paper check conversion system that utilizes the Check 21 electronic conversion system that electronically deposits checks that have been scanned with images stored. FIG. 17 illustrates this type of integration. Similar to the online bank's direct program, the information transmitted electronically for each transaction is compared using the same type of matches as described hereinabove. If exact matches are found, payments are applied to open invoices and a payment file is prepared for import to the billing software application. This process saves billers considerable time and expense related to the reconciliation of paper checks.

By accepting payments made online through the system of the present invention, automatic electronic processing is enabled of all method of payments accept for cash. The present system also provides for automatic batch close notices along with the notifications of transaction exemptions such as rejected ACH and transactions from submitted e-checks which result in email notices being sent to the payer who made the failed payment and to the biller as an alert that the payment requires reversing.

The present invention includes the ability to split out any convenience or service fees levied on payer's so that municipal and/or utility customers which prefer not to accept credit card or ACH payments, or are prohibited from doing so, can still have the invoices paid by credit card and electronic checks if the customer so chooses. When the customer pays a service fee to a third party processor instead of the biller, the present invention would instantaneously compute and present the convenience and/or service fees to the payer. These convenience and/or service fees can be altered automatically by various parameters such as bill and credit card type. The present invention automatically calculates the appropriate service fee based upon the type of credit card used and its BIN range and a variety of other settings. For example, the present invention recognizes when a Visa debit card is presented by analyzing the first four digits of the card and then determining that in fact a Visa debit card has been submitted. The present invention would then assign the special convenience fee rate specified for Visa debit cards when used to pay tax bills.

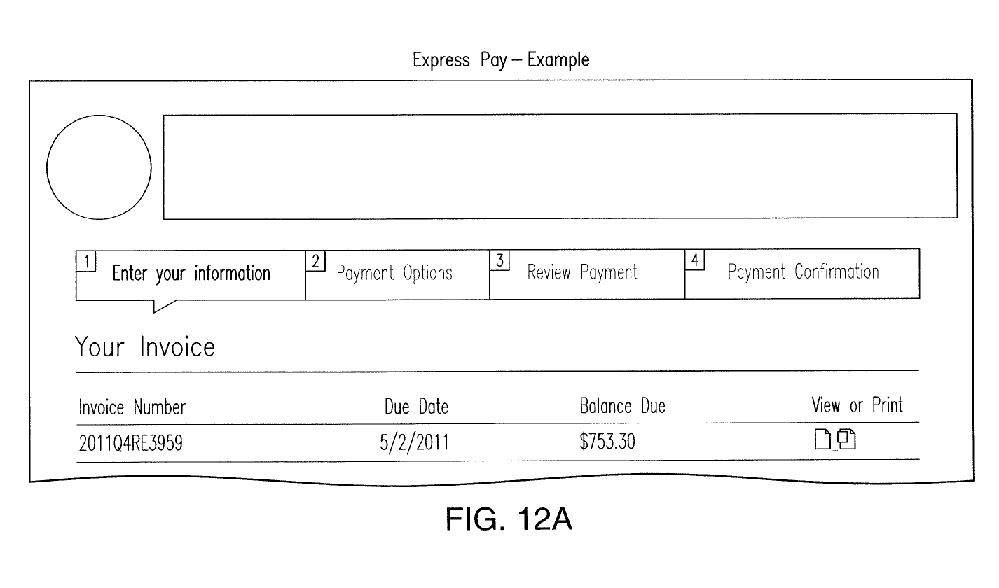

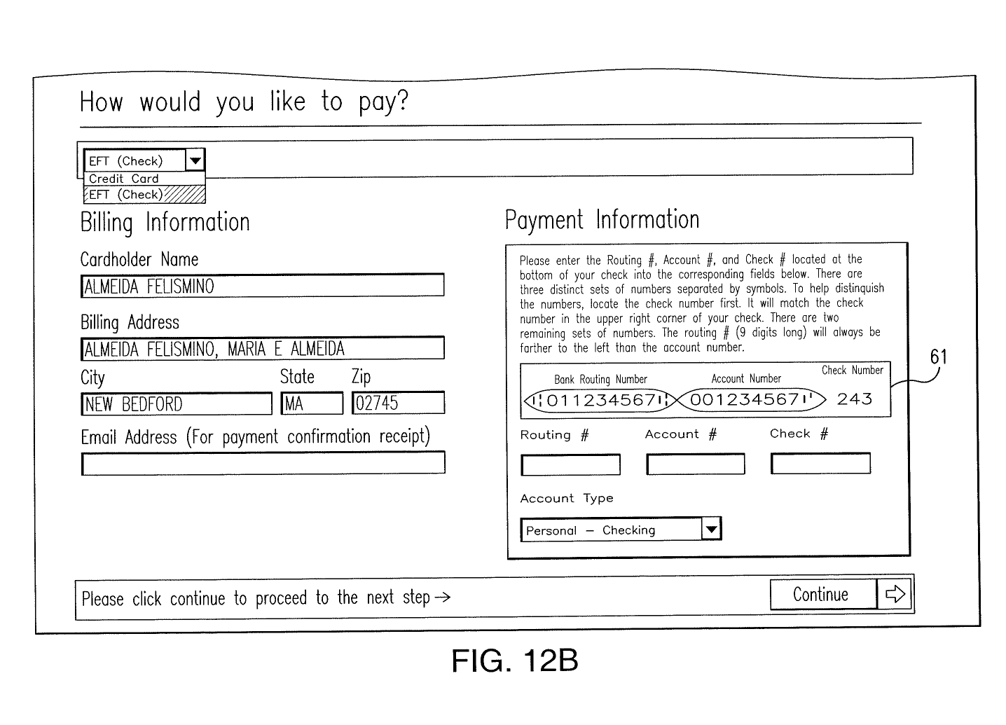

The present invention would provide a payer with the ability to make payments without registering with the service, though the express pay service of the present invention as shown in FIG. 12 would allow payers to make one-time payments without storing the payment information remotely for future use.

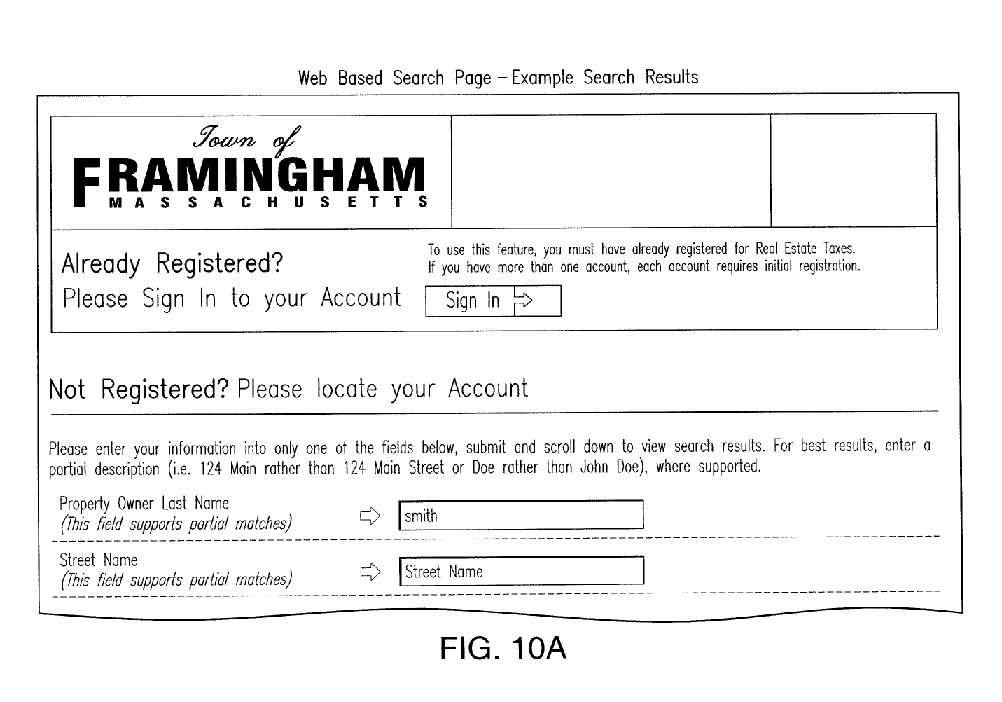

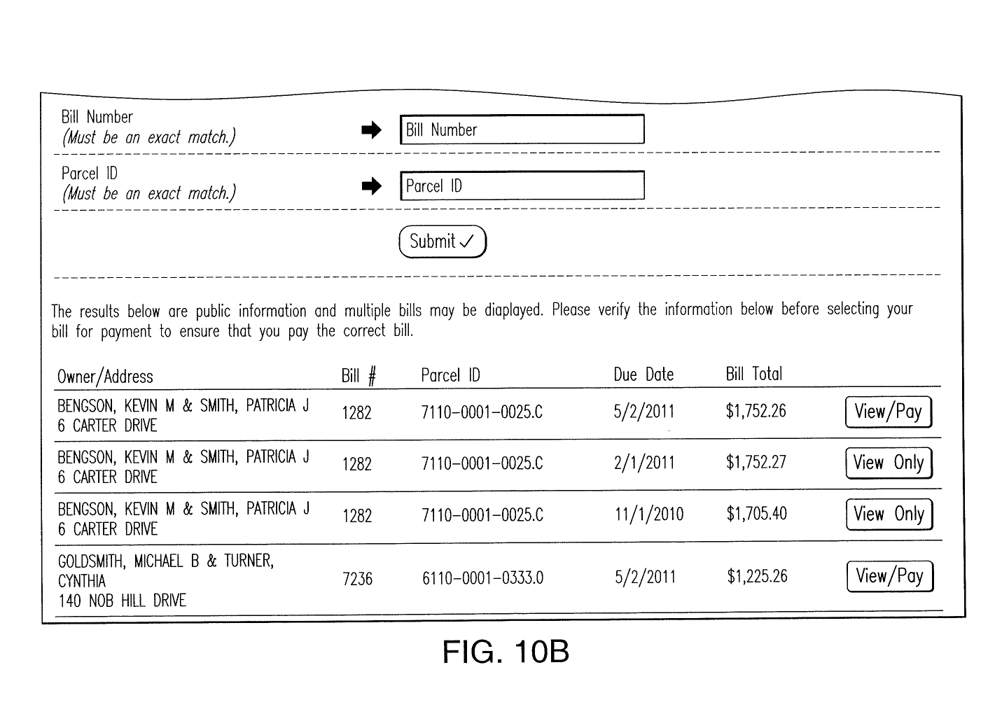

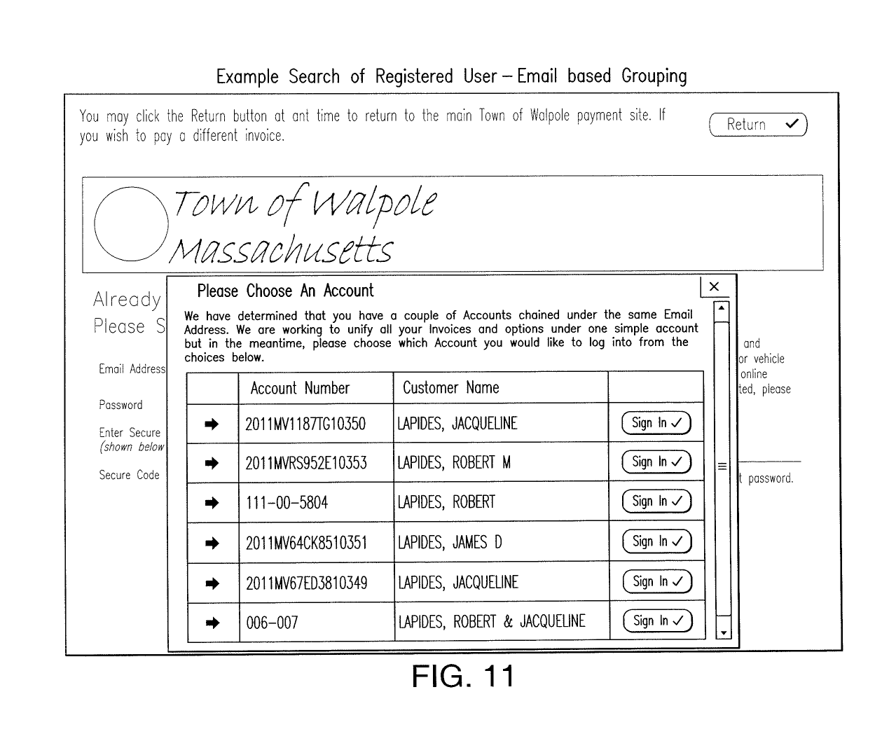

FIGS. 10 and 11 show examples of web based search options for users that can be performed by the payer. FIG. 10 shows a screen in which it four people had Smith in their name. FIG. 11 shows an example of an email based upon the grouping of a registered user utilizing the same email address and password. This feature would allow multiple invoices to be easily prepared and sent to a particular email address.

FIG. 13 illustrates an example of scheduling a payment. The payer would select a payment date utilizing the calendar 62 and either select a saved payment method or add a new bank account or credit account for the payment. This example includes the utilization of a checking account as the default payment type as well as a credit card and savings account payment option.

Referring back to FIG. 12, the screen shown thereon has a check number request field in box 61 allowing the payer to enter the accounts routing number, account number, as well as check number and type of account. Because some paper checks have recently been printed by certain banks with check numbers listed in the MICR image of a check between the routing number and the account number instead of the traditional placement to the right of the account number, the present invention will allow for this configuration. By entering the check number, the present invention automatically recognizes when check numbers are included in listed account numbers, triggering a warning notice to the payer to validate that the account number is correct because the system recognizes that the check number is encountered in the account number.

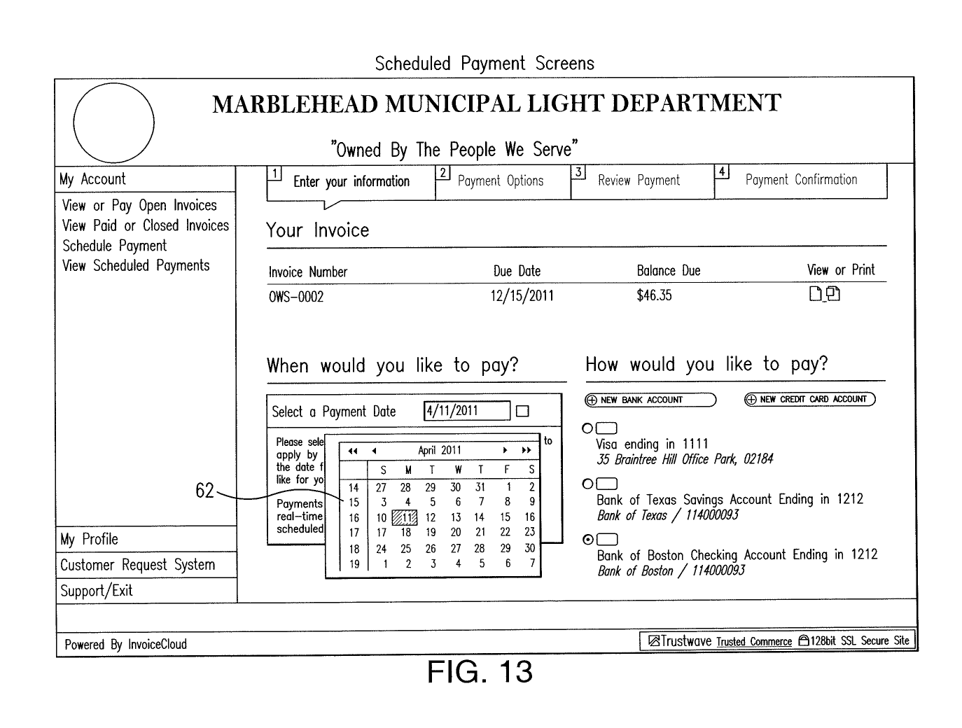

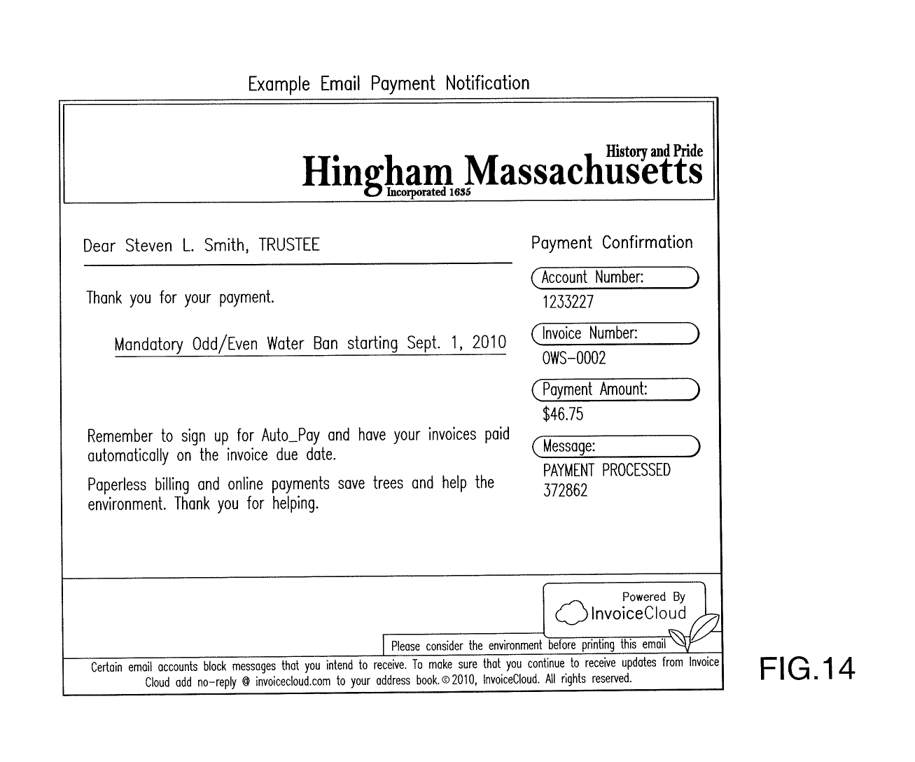

FIG. 14 shows a typical email notification sent to the payee indicating that a particular invoice has been paid.

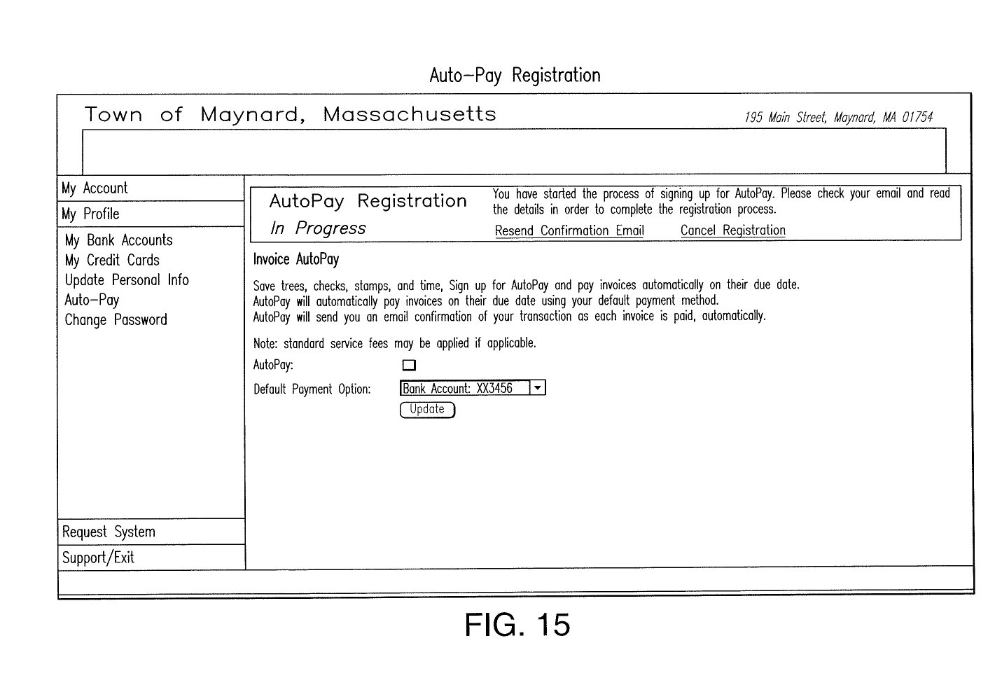

FIG. 15 illustrates a screen used with the auto pay registration. When a payer opts for the auto pay option, an email would be sent to confirm this request. The payer must complete this auto payment registration to activate the auto pay feature.

To reduce ACH rejects, the present invention would instantaneously compare entered routing numbers provided by customers to a list of acceptable U.S. banking routing numbers. The present invention would not allow the customer to continue with the utilization of an e-check payment unless the routing number has been validated. The present invention would display the name of bank that owns the entered routing number to the customer for further validation, in case the customer enters a valid routing number for an incorrect bank.

The present invention includes an ACH swap table that would allow incorrect routing and account numbers to be swapped for correct routing and account numbers, once notified by a notification of change. The present invention would also allow auto closing of batches for credit card and ACH transactions.

The present invention complies with required red flag requirements of the federal E-Signature Act as well as state and local security and privacy requirements and the American Disabilities Act (ADA). For instant security, the present invention would encrypt all credit card numbers and account numbers instantaneously and never displays these account numbers in full form to any biller personnel or even to the customer. Rather, truncated account numbers would be displayed.

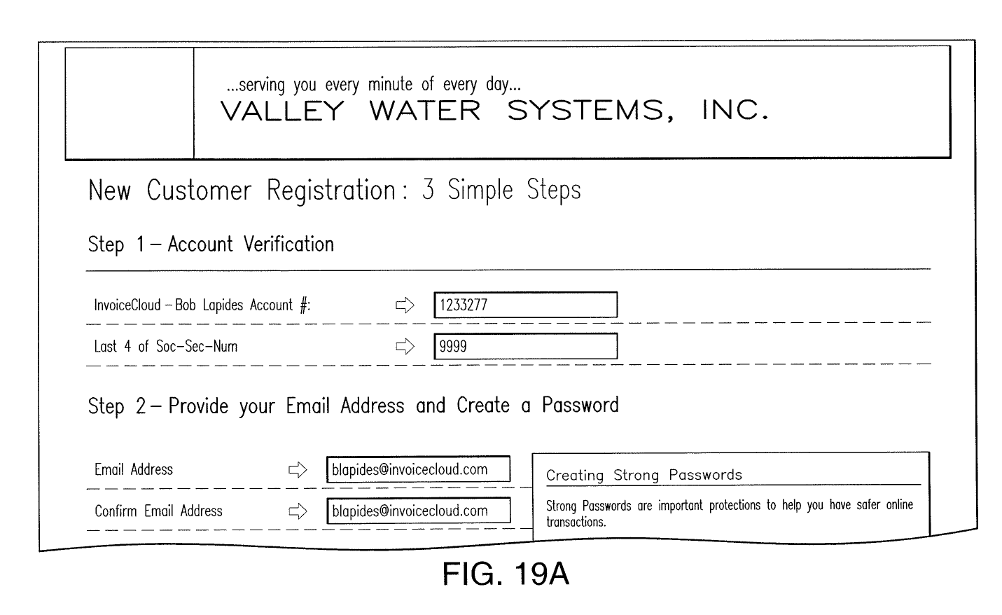

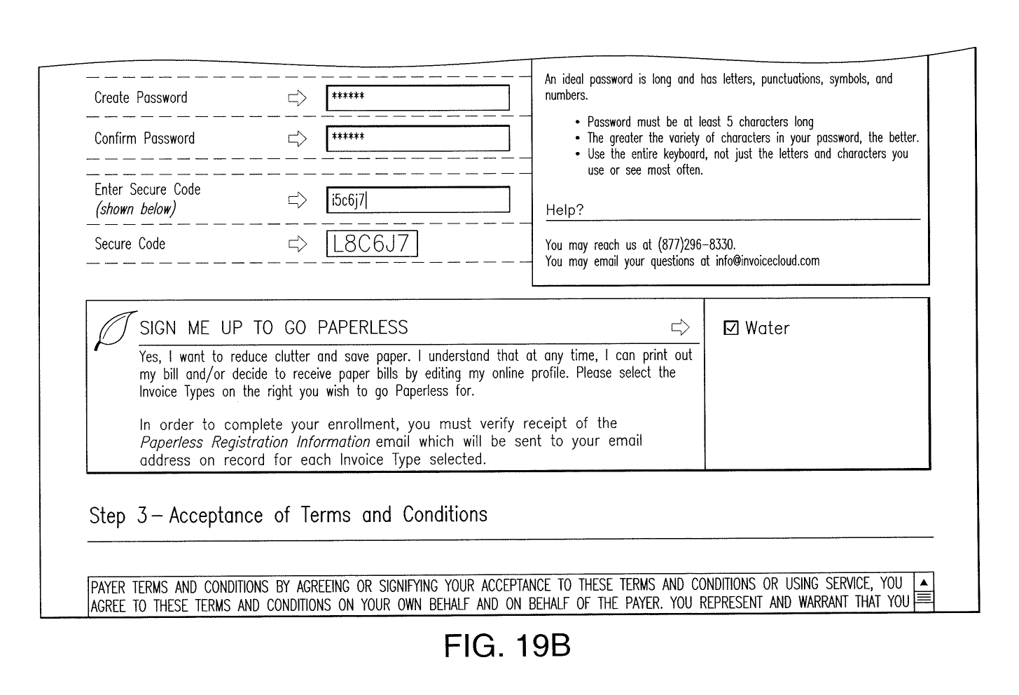

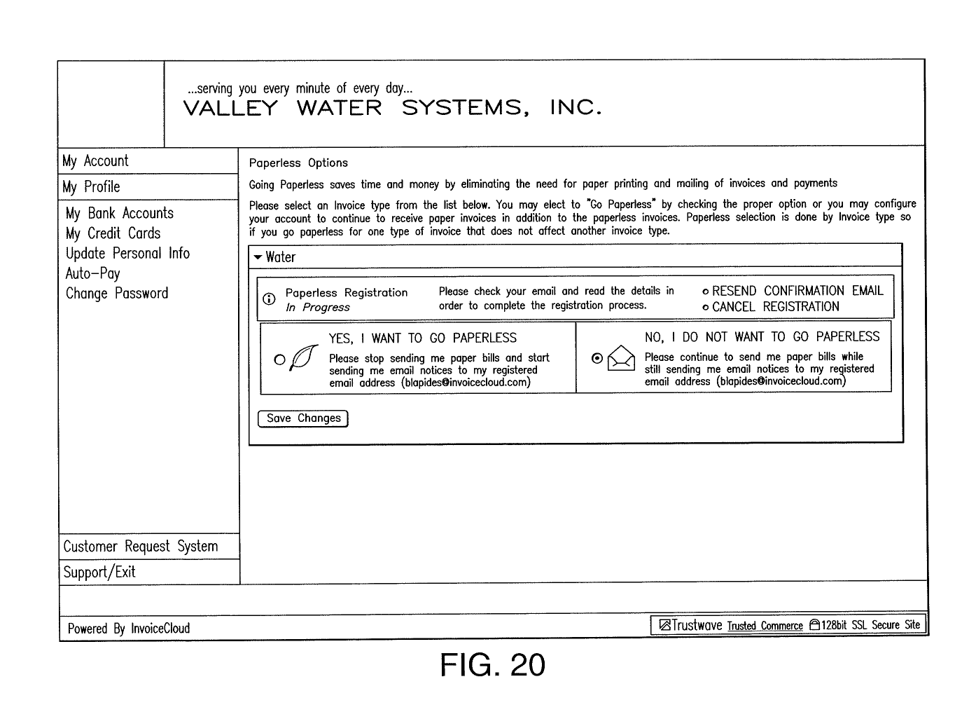

FIGS. 19 and 20 illustrate the paperless billing management system. According to the present invention, this system allows for a payer to elect to go paperless in lieu of a paper bill being sent to the payer. As shown in FIG. 19, when a new payer is being registered, that payer has the option of going paperless. If the payer chooses this option, an email is sent to the payer requiring that terms and conditions of the paperless system must be read. The payer would then verify that the terms and conditions have been read by depressing a complete registration button. This confirmation is sent to the platform of the present invention to complete the registration process. The payer would then be enrolled in the paperless process for the next bill run. The software of the present invention would then remove that particular payer from a list of payers who are sent paper bills. This would allow the billers to save money on printing and mailing costs without requiring the expenditure of labor to enter, monitor and track paperless billers.

The confirmation required by the payer would allow the present invention to conform with the federal E-Signature Act and establish a date and time stamp record for the biller to indicate all who have enrolled in the paperless billing management system. The terms and conditions read and signed by the payer clearly state that the service reserve the right to return the customer's profile to receive paper in the event that the emailed invoice notifications are returned as undeliverable.

This same process would then be used to re-enroll customers who have email notifications that are blocked by SPAM filters. The present invention provides web service methods to billers and/or their print and mailing vendors to extract the paperless billers from the print file prior to printing, thereby insuring the savings associated with paperless billing.

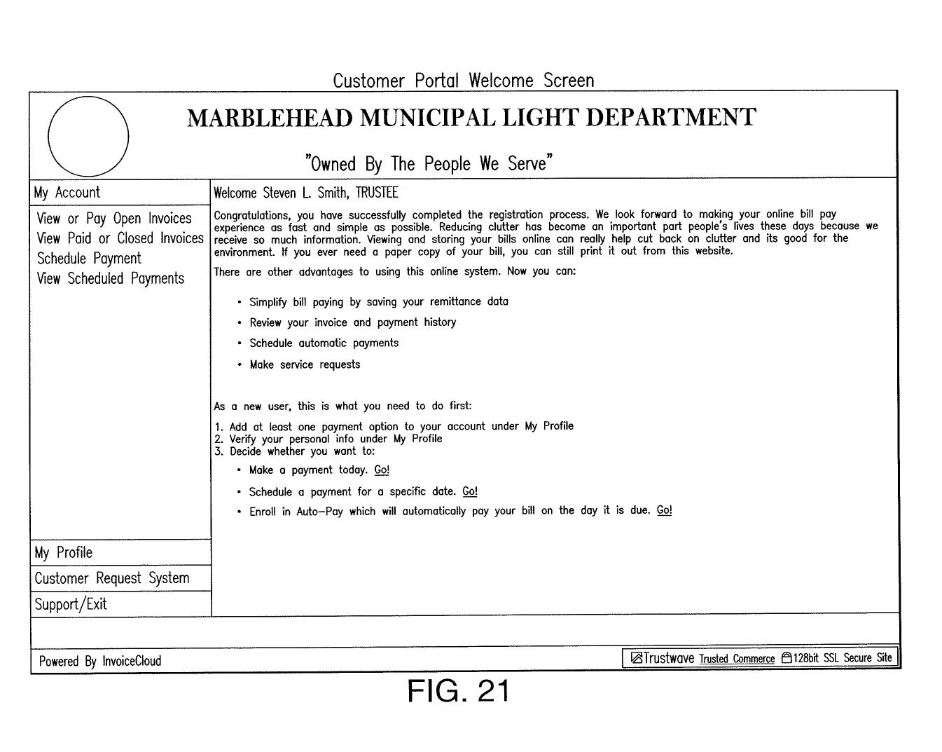

FIGS. 7-18 as well as FIG. 21 are directed to the customer portal system which allows the payer to view and pay an invoice, update information in their profile, sign up for auto pay, schedule a payment or send a request to the biller. In addition, the payer can view its history which extends for example 18 months into the past.

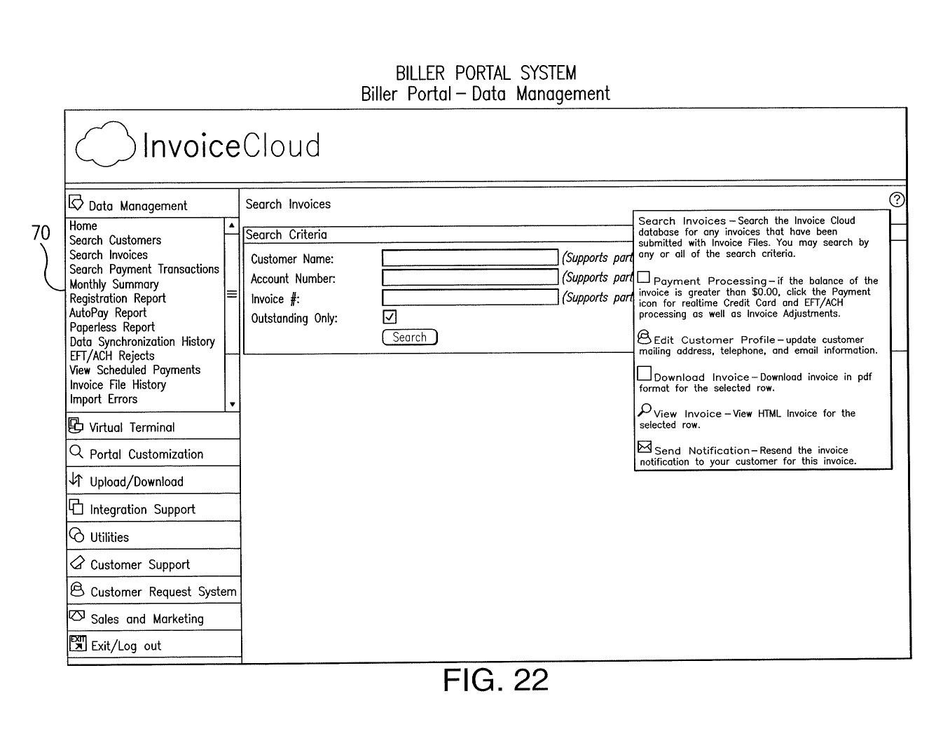

FIGS. 22-26 show frames utilized in the biller portal system. The biller portal system has a similar look and feel to the customer portal system and can be branded for selling partners who wish to resell the platform of the present invention.

As previously indicated, the customer portal system would allow the customer to pay and view one or multiple invoices as well as to set up an auto pay system and go paperless, along with the features basically described. Once the customer or payer becomes a part of the system, all information entered by the customer in the customer portal will be instantaneously transmitted to the biller portal system, allowing various personnel to view and/or manage this information as illustrated in FIG. 22. For example, when a customer enrolls in the auto pay option through its customer portal, an email is sent to the customer and explains in the terms and conditions of the program and provides the option to the customer to accept the terms and conditions of auto pay and confirm enrollment in auto pay as illustrated in FIG. 15.

As shown in FIG. 22, a drop down menu 70 divided into the following major activity categories: data management, virtual terminal, portal customization, upload/download, integration support, utilities, customer support, customer request system, sales and marketing as well as exit/logout. Each of these activity categories hosts a plurality of sub activities, commands, reports and/or configuration settings that enable the biller to manage all of the components of the present invention, along with its sub categories.

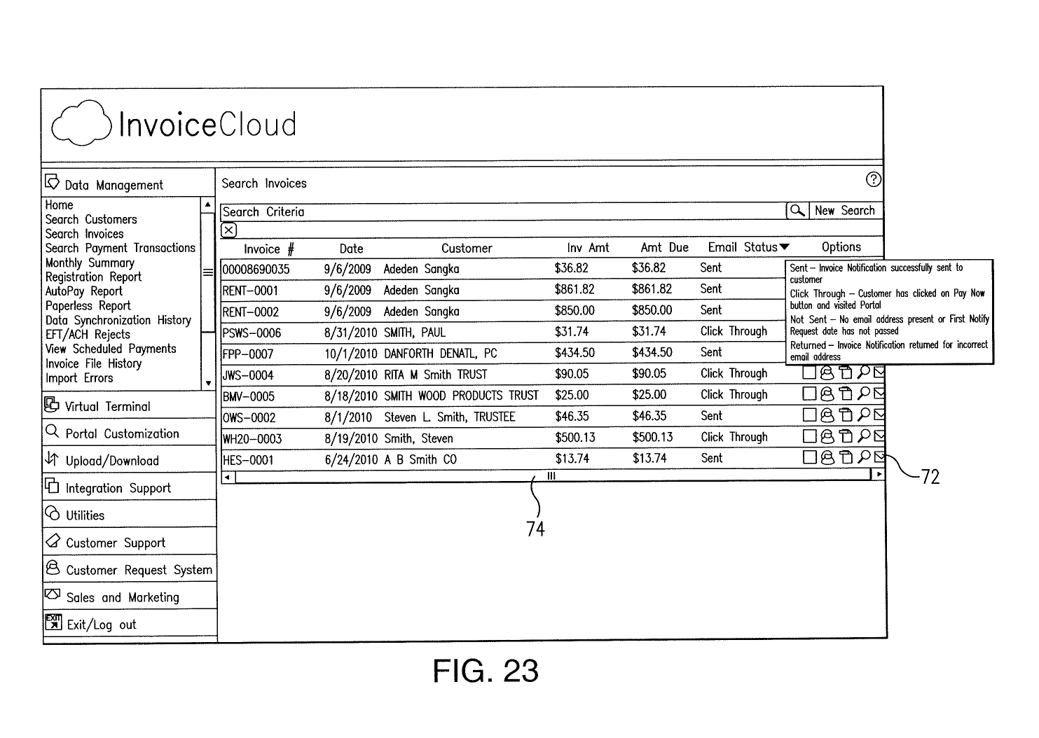

FIG. 23 illustrates a screen shot of an example of a search invoice option. The invoice amount, amount due and email status are provided in box 74. By depressing the envelope icon 72, an electronic invoice will be sent to the payer. This is useful when a new invoice needs to be produced. The biller can view the actual invoice by depressing various other icons.

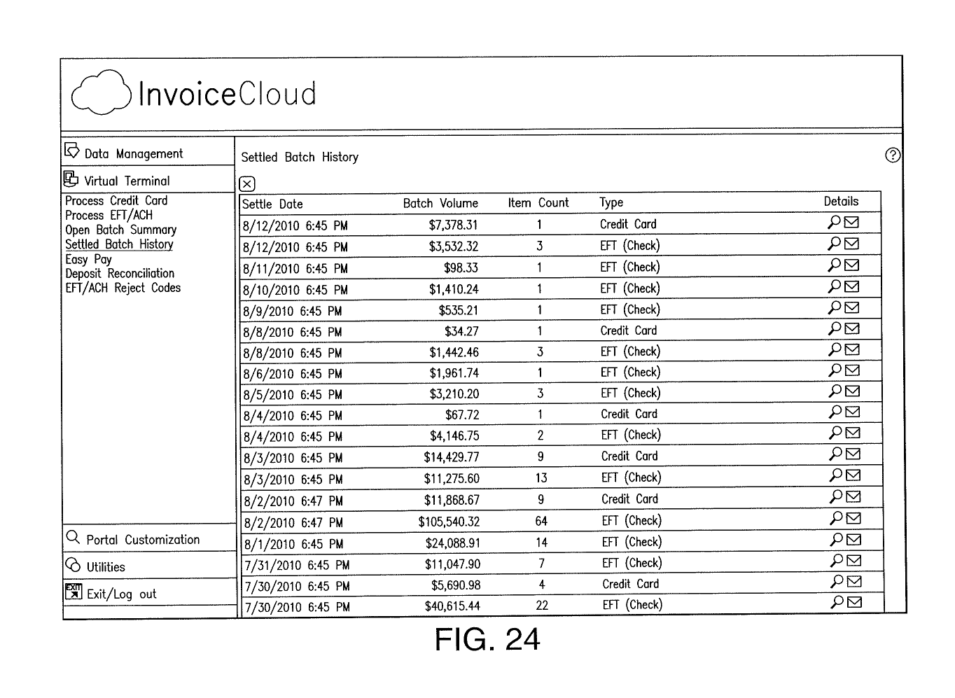

FIG. 24 shows a typical screen shot when the biller portal system is provided as a virtual terminal. This screen shot shows a settled back history of various invoices.

The various features of the biller auto system provides biller personnel with many different options, such as, but not including menu driven branding a customer portal customization, menu driven configuration management, the ability to select and trigger dates driven or instantaneous activities with respect to various email notifications, the ability to manage permissions for biller administrative personnel to accept payments in various manners, the ability to manage permissions for a payer to allow various payment options as well as paperless billing. Furthermore, the present invention has the ability to manage a customer request system as previously indicated, as well as the ability to manage data and create an unlimited number of “ad hoc” reports using various parameters such as date ranges. The present invention has the ability to create Excel spreadsheets of any report by clicking the appropriate icon. Furthermore, the present invention has the ability to view a help screen on any page when a customer depresses the proper icon. The present invention also has the ability to change email templates by bill type, the ability to change the branding of the customer portal, the ability to disable a payer and make a customer inactive, such as when a home is conveyed to a new owner as well as to enable a new owner to initiate the service.

The biller portal system can block all payments from a customer such as credit card payments or e-check payments, all at the biller's option.

The present invention will allow multiple bill types in the same user interface and allows different configurations and/or rules for different bill types within the same user interface.

The biller portal system of the present invention has a multi-user based architecture, a propriety session verification system, as well as integrated virtual terminals as shown in FIG. 24 which allows manual entry of offline payments, integrates with the Check 21 program and integrates with the online bank direct program. The present invention would allow biller enabled maintenance windows to prevent customers from paying during system maintenance periods, and enables the ports to be exported with one click to the Excel spreadsheet. The present invention would allow credit card and ACH batches to be reviewed and edited by a biller without intervention. This would allow biller personnel to delete a transaction prior to the batch being sent out to the government for settlement if a payer calls the biller on the same day because it made an error in payment. For example, if one individual in a household has paid a tax bill by cash at the cashier's window and another individual makes an e-check payment through the customer portal or through express pay, one of the transactions can be removed from the batch.

The biller portal system includes a portal customization feature allowing the biller to use a word processor type editor to easily and rapidly modify the email notification templates as previously discussed.

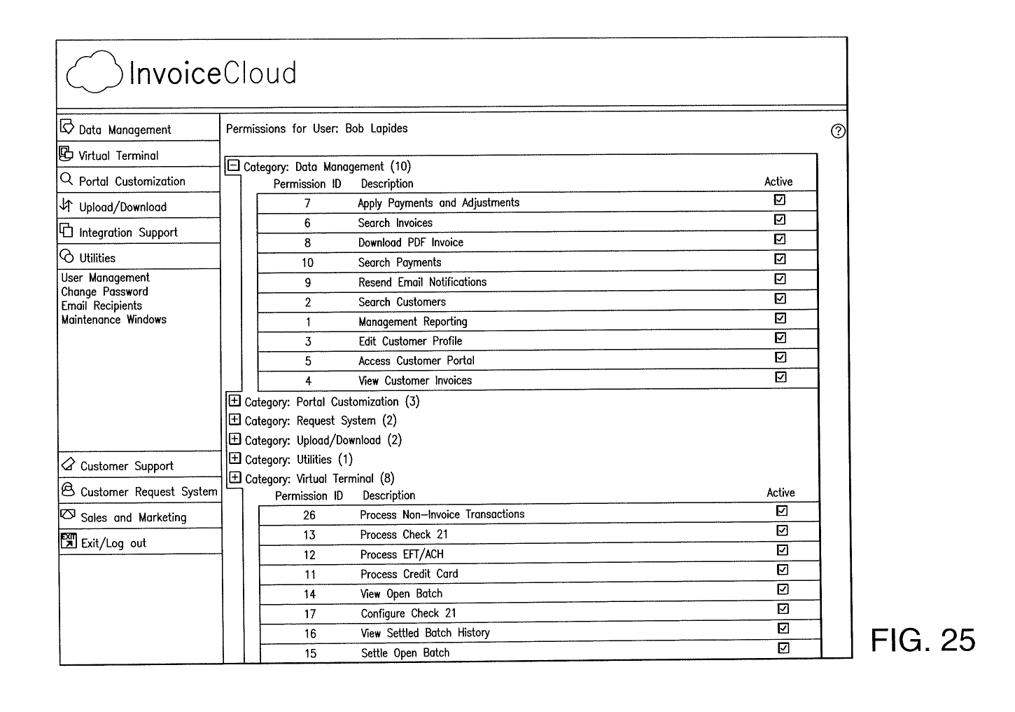

As shown in FIG. 25, the biller portal system includes a utilities section allowing the biller to manage the permission by the administrative user to make certain changes, such as to allow the change of a password.

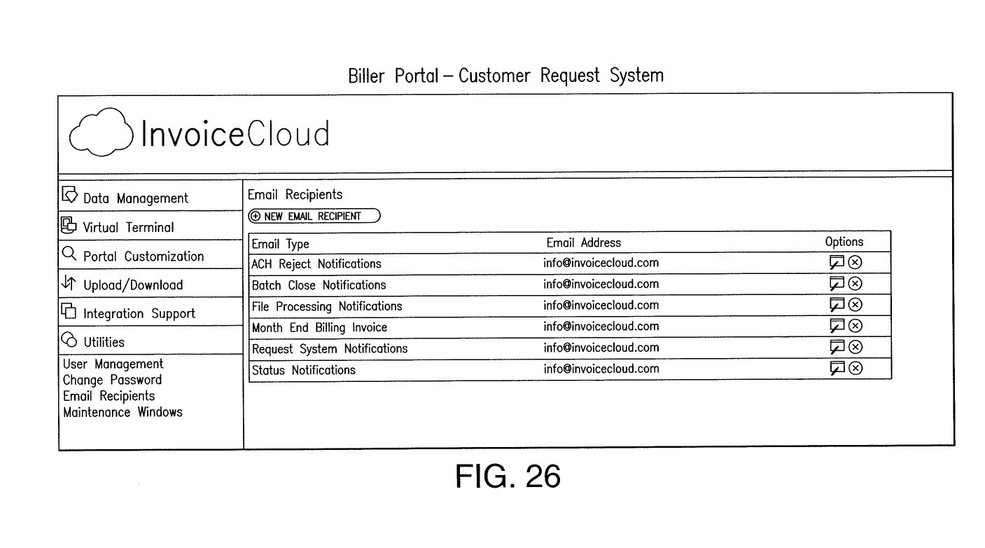

FIG. 26 displays various aspects of the email recipient management system.

While the preferred embodiments have been shown and described, it will be understood that there is no intent to limit the invention by such disclosure, but rather, is intended to cover all modifications and alternate constructions falling within the spirit and scope of the invention.

1. A system for generating an invoice by a biller to be forwarded to a customer/payer for its review comprising:
a software file exchange platform integrated with a biller's software, said software including one or more billing software solutions to create a database used to allow the biller to produce web based search pages to be accessed by the customer/payer, said database containing information relating to at least one bill incurred by the customer/payer and stored on a web server,
said web based search pages allowing the customer/payer access and/or view to at least one invoice detailing at least one bill incurred by the customer/payer, said web based search pages providing the customer/payer with a means for directly paying said at least one invoice.

2. The system in accordance with claim 1, wherein said web based search page is a virtual site which includes logos or other information indicating that a particular biller is the source of the invoice or bill incurred by the customer/payer.

3. The system in accordance with claim 1, wherein multiple invoices are accessed by the customer/payer.

4. The system in accordance with claim 3, wherein the customer/payer can pay all of the invoices at one time.

5. The system in accordance with claim 3, wherein the customer/payer can fully pay some, but not all of the invoices.

6. The system in accordance with claim 3, wherein the customer/payer can pay less than the full amount of the invoices.
